(19) United States
(12) Patent Application Publication
(10) Pub. No.: US 2025/0157275 A1
(43) Pub. Date: May 15, 2025

(54) Voting App

(71) Applicant: James Kollasch, Des Moines, WA (US)

(72) Inventor: James Kollasch, Des Moines, WA (US)

(21) Appl. No.: 18/794,050

(22) Filed: Aug. 5, 2024

Related U.S. Application Data
(63) Continuation-in-part of application No. 18/388,625, filed on Nov. 10, 2023, now abandoned.

(51) Int. Cl. G07C 13/00; H04L 9/40

(52) U.S. Cl. CPC G07C 13/00; H04L 63/08

(57) ABSTRACT

A system to manage secure voting for a registered voter allows a registered voter to securely vote in an election is disclosed. The system may include obtaining voter registration information; securely authenticating based on identifying information provided by the registered voter and matching the identifying information with a voter registration record; providing, by a secure ballot application, a ballot for the election, with candidate information, propositions in the election, instructions for completing the ballot or a combination thereof; determining from historical preferences, candidate information, personal profile of the registered voter, proposition background or the like, a selection of a preferred candidate and/or proposition; securely recording a registered voter selection for selected candidate and/or proposition; securely transmitting, the selected candidate and/or proposition to a secure voting recordation database; and storing the selected candidate and/or proposition in a secure registered voter database associated with and only accessible by the registered voter.

This continuation-in part application claims priority to U.S. application Ser. No. 18/388,625, titled “Voting App”, filed Nov. 10, 2023, the entirety of which is incorporated here by reference.

### TECHNICAL FIELD

The present disclosure relates, in general, to electronic voting, and, more particularly, but without limitation, to a secure voting and ballot system.

### BACKGROUND

In all cases, today's electronic/interactive voting has significant limitations. This includes long lines at the polling places, insufficient number of polling places, polling places open only at inaccessible times, resulting in an inestimable number of people who fail to vote.

Absentee voting ballots are cast before the actual voting day, potentially missing out on information about candidates and/or propositions that arise prior to election day. Many absentee votes never get counted because jurisdictions often treat them as provisional ballots and only count them if the race is very close. Other jurisdictions require certain thresholds to be met in order to count absentee votes.

Cell phones and tablets and the like are ubiquitous across the globe. Internet access is available for free at restaurants and even public libraries. Connectivity is at an all-time high. Interactivity when used in a relaxed environment can help the voter navigate and prevent many voter errors. The combination of interactivity and readily available internet access is a potentially powerful combination. A voter who can research issues/candidates while voting is a more informed voter. Informed voters are the essence of democracy.

Voting should be a cut and dried procedure but unfortunately it is open to fraud and corruption when the stakes involve public policy. As such, many steps have been taken to insure fair and correct voting methods and fair and correct access to voting venues or not. People have made voting machines, when counting votes was found to onerous a burden and fraught with errors. Even voting machines have been made suspect in different states or communities across the country. Therefore, a need exists for a new method of voting that everyone can vote with and that is secure and readily accessible for everyone.

### SUMMARY

In an aspect of the disclosure, computer implemented method to manage secure voting for a registered voter is disclosed. The method may include obtaining voter registration information about the registered voter desiring to cast a vote in an election; securely authenticating the registered voter based on identifying information provided by the registered voter and matching the identifying information with a voter registration record; providing, by a secure ballot application, a ballot for the election, where the ballot comprises at least one of candidate information, propositions in the election, instructions for completing the ballot or a combination thereof; determining, by the secure ballot application, from historical preferences, candidate information, personal profile of the registered voter, proposition background or a combination thereof, a selection of a preferred candidate and/or preferred proposition for the registered voter; securely recording a registered voter selection for a selected candidate and/or selected proposition; securely transmitting, via the secure ballot application, the selected candidate and/or selected proposition to a secure voting recordation database; and storing the selected candidate and/or selected proposition in a secure registered voter database associated with and only accessible by the registered voter.

In an aspect of the disclosure, a system to manage secure voting for a registered voter is disclosed. The system may include at least one memory configured to store computer executable instructions; and at least one processor configured to execute the computer executable instructions to: obtain voter registration information about the registered voter desiring to cast a vote in an election; securely authenticate the registered voter based on identifying information provided by the registered voter and matching the identifying information with a voter registration record; provide, by a secure ballot application, a ballot for the election, where the ballot comprises at least one of candidate information, propositions in the election, instructions for completing the ballot or a combination thereof; determine, by the secure ballot application, from historical preferences, candidate information, personal profile of the registered voter, proposition background or a combination thereof, a selection of a preferred candidate and/or preferred proposition for the registered voter; securely record a registered voter selection for a selected candidate and/or selected proposition; securely transmit, via the secure ballot application, the selected candidate and/or selected proposition to a secure voting recordation database; and storing the selected candidate and/or selected proposition in a secure registered voter database associated with and only accessible by the registered voter.

In an aspect of the disclosure, a computer program product is disclosed. The computer program product may include a non-transitory computer readable medium having stored thereon computer executable instructions, which when executed by one or more processors, cause the one or more processors to carry out operations to manage secure voting for a registered voter. the operations comprising: obtaining voter registration information about the registered voter desiring to cast a vote in an election; securely authenticating the registered voter based on identifying information provided by the registered voter and matching the identifying information with a voter registration record; providing, by a secure ballot application, a ballot for the election, where the ballot comprises at least one of candidate information, propositions in the election, instructions for completing the ballot or a combination thereof; determining, by the secure ballot application, from historical preferences, candidate information, personal profile of the registered voter, proposition background or a combination thereof, a selection of a preferred candidate and/or preferred proposition for the registered voter; securely recording a registered voter selection for a selected candidate and/or selected proposition; securely transmitting, via the secure ballot application, the selected candidate and/or selected proposition to a secure voting recordation database; and storing the selected candidate and/or selected proposition in a secure registered voter database associated with and only accessible by the registered voter.

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 shows components of one aspect of a computing environment for providing secure voting for a registered voter, according to an aspect of the disclosure.

FIG. 2 shows one aspect of a client computer for providing secure voting for a registered voter.

FIG. 3 shows one aspect of network computer that may at least partially implement one of the various aspects.

FIG. 4 illustrates an exemplary block diagram of a secure voting system and application.

FIG. 5 illustrates a flowchart for acts taken in an exemplary method for providing secure voting for a registered voter.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the following description, numerous specific details are set forth to clearly describe various specific aspects disclosed herein. One skilled in the art, however, will understand that the presently claimed disclosure may be practiced without all of the specific details discussed below. In other instances, well-known features have not been described so as not to obscure the disclosure. As described herein, the term “pivotally connected” shall be used to describe a situation wherein two or more identified objects are joined together in a manner that allows one or both of the objects to pivot, and/or rotate about or in relation to the other object in either a horizontal or vertical manner. As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to exemplify aspects of the disclosure and that other alternative mechanical configurations are possible.

The disclosed voting system may remove all obstacles previously found in voting by creating a secure voting system and application to be accessed through any electronic device to firstly ask if the person accessing is a registered voter. Then, using the device's camera function, the secure voting system and application may capture a photo of acceptable I.D. or green card or any acceptable I.D. that is acceptable within current voting laws. In an aspect, the disclosed voting system may prompt the voter with security questions to verify the identity of the voter, such as pre-generated answers to security questions only the voter would know. The secure voting system and application may have a current ballot entered into the secure voting system and application including all the candidates and proposed bills and will be available in many languages.

The secure voting system and application will be accessible to anyone who has a mobile phone or laptop computer or any computer that can access the secure voting system and application on their device. The current ballot will need to be downloaded to the secure voting system and application for every election. Voting through the secure voting system and application on everyone's personal device will greatly enhance the security of the voting process. There will be no need for paper ballots, no need to have postage, no need for absentee ballots, no need for voting venues, to be appropriated and staffed. Communities will save billions of dollars. This secure voting system and application can be used on any phone, computer any electronics that can download or access the secure voting system and application. Libraries also have computers that the public can access, so this will also be an avenue for people to vote if they don't have their own devices. The secure voting system and application can be downloaded on every library computer increasing the availability of voting access for everyone. Likewise, someone can use their friend's phone or computer if they do not have one by having the user provide their home address and contact information. The secure voting system and application will produce a receipt of the all of the user's votes so the user will be assured that their vote has been counted. The disclosed voting system may ask the user if the user wants to save the user preferences for future voting. In an aspect, the disclosed voting system may ask the user if the user wants a copy of the receipt for the ballot, whether paper, certified digital transmission or other record of the user's vote on the ballot. Accurate and swift counting of the vote is realizable with the secure voting system and application. Artificial Intelligence (AI) may be used to ensure no bias and the voting APP will only count what it receives in the vote. This provides for extreme security. When the user is finished voting on their ballot, there is an option to make changes if so desired. Also a red flag is raised if the information supplied is not complete or does not match what had been entered so far, and instructions are on what the user can do next will be provided. In addition, the secure voting system may verify if a user's ID address used does not match the ID move to which address the user will be voting from and reject such an attempted vote. In an aspect, the secure voting system may verify if a voting attempt timestamp matches with the proper dates and times of a schedule voting session. In an aspect, if voter registration information cannot be verified online, the secure voting system may refer the user to request and use a mail-in ballot. All results will be reported to the proper government office. This secure voting system and application prevents the compromising of or some government office being bought.

The disclosed voting system, according to an aspect of the disclosure, is beneficial for all candidates because it makes certain that their points are heard as they were intended. Instead of going through T. V. or newspapers where oftentimes the media do not portray exactly what the candidate said but instead the candidates message gets distorted or the media only plays the part of the message that suits their bias or political beliefs.

In an aspect of the disclosure of the invention, as long as there is no conflict of interest, advertising space can be sold to candidates on the secure voting system and application. The secure voting system and application will show the candidates photo by the bill and or office they are seeking, the user can click on it and get a 30 second/I minute synopsis of their views on that issue. In the secure voting system and application, candidates are precluded from criticizing other candidates or previous administrations. Only their stance on the proposed bill or just a general stance on how they will make better the office that they seek will be allowed on the secure voting system and application.

In an aspect of the disclosure of the invention, the secure voting system and application can become a conduit for candidates to do advertising and a way for candidates to reach all their constituents. This secure voting system and application would enable candidates to advertise to all of their voters, State, city, parish, United States or (worldwide if necessary). Using the APP to campaign would greatly reduce the amount of campaign funds candidates would need to campaign. Just click on the candidate's name or picture and get a full synopsis of their views and stances on certain issues. This secure voting system and application, according to an aspect of the disclosure, is beneficial for all candidates because it makes certain that their points are heard as they were intended. Instead of going through T.V. or newspapers where oftentimes the media do not portray exactly what the candidate said but instead the candidates message gets distorted or the media only plays the part of the message that suits their bias or political beliefs.

According to an aspect of the disclosure, when candidates campaign through the secure voting system and application and reach anyone who has a computer or phone, then the candidates can travel for personal appearances to the places that they think would be best for their campaign.

In an aspect of the disclosure of the invention, the secure voting system and application can receive public information of political poll results for any given community, constituent political affiliations, current issues the community is facing, and using this information, can determine those areas the candidate should be campaigning. In a further aspect, the secure voting system may be used to take polls of registered voters on issues a candidate may be interested in supporting, declaring support or testing the waters on voter opinions on certain issues and platforms. The secure voting system would allow a candidate, polling organization, news organization, political action committee or other interested parties to request polling information from registered voters using the secure voting system. The polling feature of the secure voting system may allow opt-ins, opt-outs, and/or selections to pay registered voters for polling information. Currently, polling is done usually at low levels involving relatively small samples sizes compared to the voting population. With the ubiquity of smartphones and mobile smart devices, polling can be done on large segments of the population at lower cost. At the same time, paying registered voters to provide their opinions may be done at lower cost than engaging expensive polling organizations, pollsters and employees to canvass or call registered voters. The security and anonymity built into the secure voting system may encourage registered voters to voice their opinions more freely than when confronted with a robocaller or door-to-door canvasser in the communities.

In an aspect of the disclosure the secure voting system and application has a red flag detection system for incorrect information and signature recognition. This will save $100's of millions in paper cost, and another $100s of millions of not billions in return postage. The government is set to pay the USPS $5 billion dollars to send out the ballots, which would be saved by this secure voting system and application.

Aspects of the disclosure relate to methods and apparatus for a government system with the capacity for counting millions of votes within a short amount of time.

In an aspect of the disclosure, the secure voting system and application, once the ballot is provided, will then guide them through the voting procedure to make sure all spots are filled in including a non-vote. Then the secure voting system and application will ask if they want to make any changes before submitting choices. Finally, the secure voting system and application will ask the user if they would like a receipt of their voting.

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

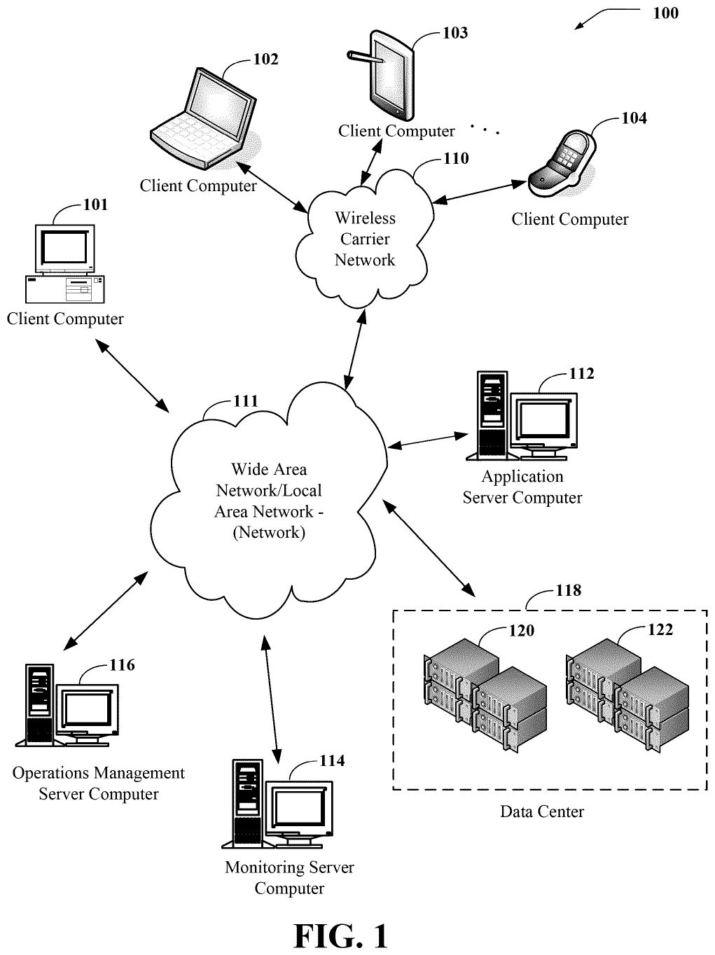

FIG. 1 shows components of one aspect of a computing environment 100 for providing secure voting for a registered voter, according to an aspect of the disclosure. Not all the components may be required to practice various aspects, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement the disclosed lung nodule tracker and patient test reminder system.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one aspect, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one aspect, one or more of the client computers 101-104 may be configured to operate within a secure voting services company, regional, state or federal voting office or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other aspects. Further, it should be recognized that more or less client computers may be included within a system such as described herein, and aspects are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one aspect, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, or the like, to display and send a message. In one aspect, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, the wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. In essence, the network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

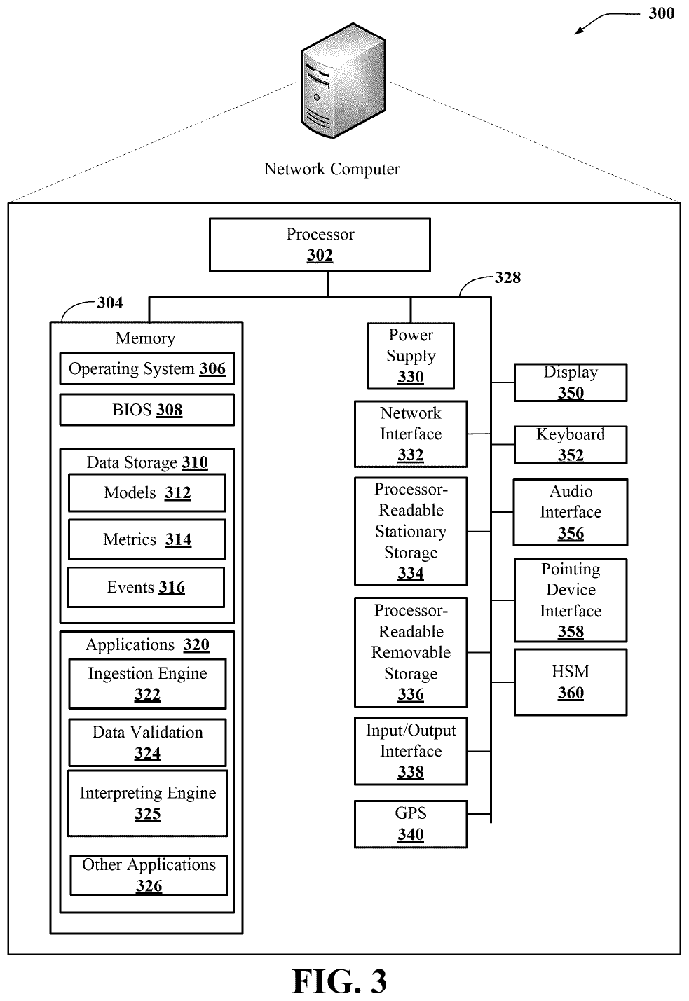

The operations management server computer 116 may include virtually any network computer usable to provide computer operations management services, such as a network computer, as described with respect to FIG. 3. In one aspect, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various aspects, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some aspects, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the disclosure is not so limited. Thus, the operations management server computer 116 may represent a plurality of network computers. For example, in one aspect, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some aspects, one or more data centers, such as a data center 118, may be communicatively coupled to the wireless network 110 and/or the network 111. In at least one of the various aspects, the data center 118 may be a portion of a private data center, public data center, public cloud environment, or private cloud environment. In some aspects, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some aspects, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various aspects, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

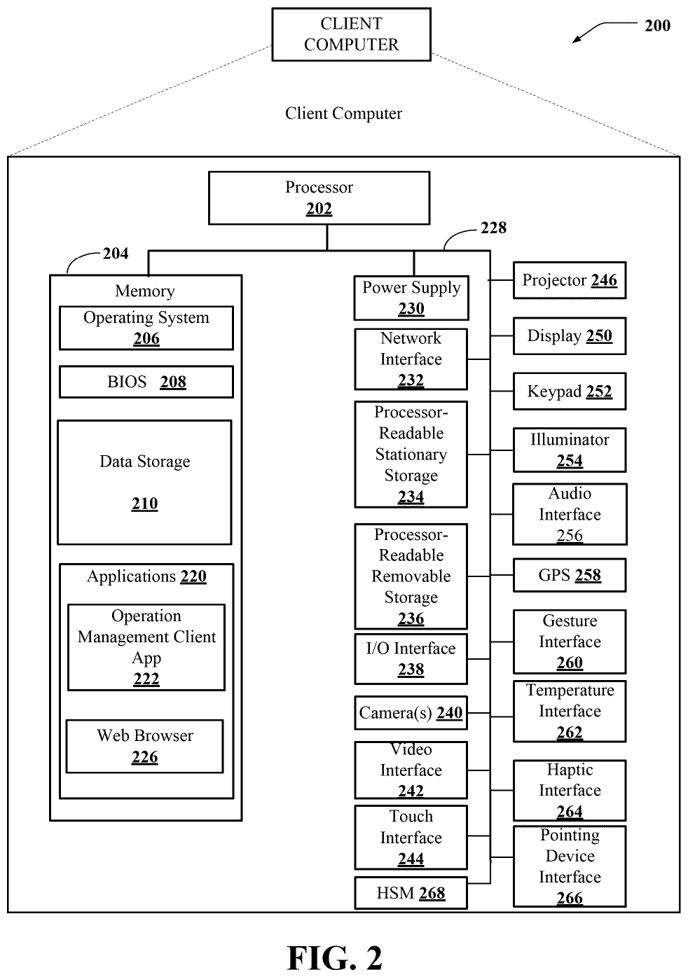

FIG. 2 shows one aspect of a client computer 200 for providing secure voting for a registered voter. The client computer 200 may include more or less components than those shown in FIG. 2. The client computer 200 may represent, for example, at least one aspect of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one aspect, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one aspect, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one aspect, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one aspect, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various aspects, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more aspects (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the client computer 200 may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one aspect of network computer 300 that may at least partially implement one of the various aspects. The network computer 300 may include more or fewer components than those shown in FIG. 3. The network computer 300 may represent, for example, one aspect of at least one secure voting system and application according to the disclosure, such as the operations management server computer 116 of FIG. 1, the monitoring server computer 114 of FIG. 1, or an application server computer 112 of FIG. 1. Further, in some aspects, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™ Firewire™, WiFi, WiMax, Thunderbolt™, Infrared, Bluetooth™, Zigbee™, serial port, parallel port, and the like.

Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one aspect, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below, including instructions to enable the disclosed lung nodule tracker and patient test reminder. In one aspect, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like. Other data records included in the data storage 310 may include computer code instructions and/or algorithms for executing a trained machine learning model that is capable of assisting the secure voting system and application to recommend certain candidates or propositions up on a current ballot. In an aspect, the trained machine learning model may include an artificial intelligence model, a Bayesian inference model or other machine or statistical learning model.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may include an ingestion engine 322, a data validation engine 324, interpreting engine 325, or other applications 327. In at least one of the various aspects, one or more of the applications may be implemented as modules or components of another application. Further, in at least one of the various aspects, applications may be implemented as operating system extensions, modules, plugins, or the like. In an aspect, the applications 320 may include instructions to implement the secure voting system and application.

Furthermore, in at least one of the various aspects, the ingestion engine 322 for receiving registered voter and candidate information related to the disclosed secure voting system and application, the data validation engine 324 for confirming data integrity and applicability for processing by the system, the interpreting engine 325 for interpreting, parsing and presenting at least one of a candidate information set and/or a proposition information set, and/or other applications 326, or the like, may be operative in a cloud-based computing environment. In at least one of the various aspects, these applications, and others, that comprise the management platform may be executing within virtual machines or virtual servers that may be managed in a cloud-based based computing environment. In at least one of the various aspects, in this context the applications may flow from one physical network computer within the cloud-based environment to another depending on performance and scaling considerations automatically managed by the cloud computing environment. Likewise, in at least one of the various aspects, virtual machines or virtual servers dedicated to the ingestion engine 322, the data validation engine 324, the matching engine 325, and/or the other applications 326, may be provisioned and de-commissioned automatically.

Also, in at least one of the various aspects, the ingestion engine 322, the data validation engine 324, the interpreting engine 325, and/or the other applications 326, or the like, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, blockchains, hashes or the like. In some aspects, hardware security module may be employed to support one or more standard public key infrastructures (PKI), and may be employed to generate, manage, or store keys pairs, or the like. In some aspects, the HSM 360 may be a stand-alone network computer, in other cases, the HSM 360 may be arranged as a hardware card that may be installed in a network computer.

Additionally, in one or more aspects (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the network computer may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

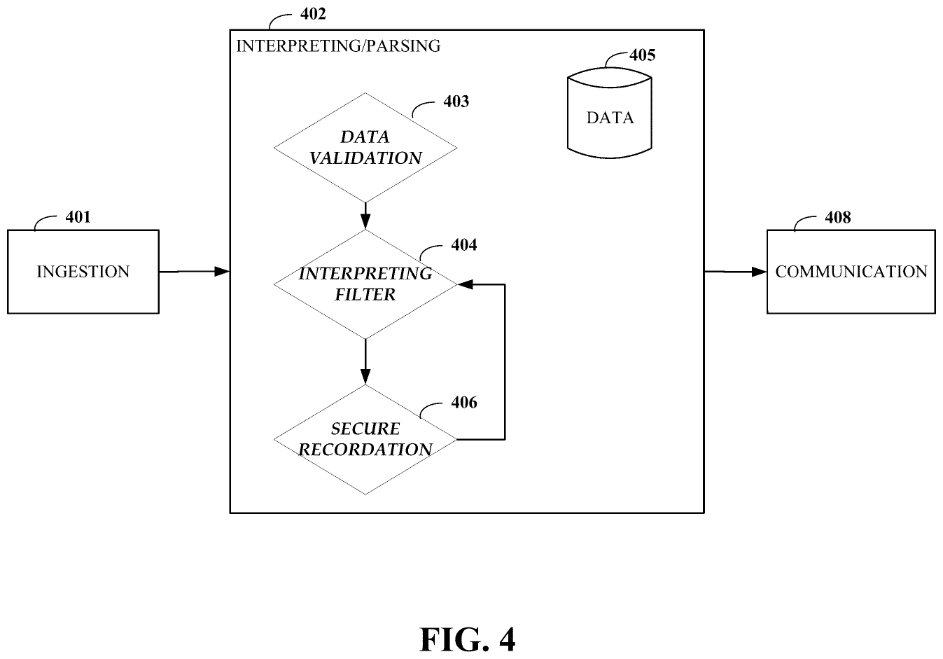

FIG. 4 illustrates an exemplary block diagram of a secure voting system and application 400, according to an aspect of the disclosure. The system 400 includes a registered voter information and candidate/proposition input system or ingestion engine 401, where a registered voter's registration, demographic, personal identification, authenticating information and other voting information relevant to a current election or ballot is provided to the system. As described herein, registered voter information may include information about a voter's registration information, demographic information, personal information, voting preferences, party affiliations, political positions, past voting information, authenticating information or other information relevant to the registered voter and/or election/ballot. The registered voter information is transferred to the interpreting/parsing engine 402 for organizing and filtering the registered voter information in line with the current election/ballot to prepare a secure ballot for the registered voter by the secure ballot application. At data validation engine 403, the system processes the registered voter information to confirm data quality, conformity with standards for input and processing, format for proper ballot preparation and input fields for the registered voter or other data validation steps needed for further processing by the interpreting/notification engine 402.

An interpreting filter engine 404 may be used to determine, based on the registered voter information, and from historical preferences, candidate information, personal profile of the registered voter, proposition background or a combination thereof, a selection of a preferred candidate and/or preferred proposition for the registered voter to review and select from. The interpreting filter engine 404 may then use a trained machine learning model, such as an artificial intelligence model to prepare and present a selection of a recommended preferred candidate and/or preferred proposition for the registered voter to review and select from. Based on the results from the presentation of the candidates and/or propositions for the registered voter to select, a secure recordation engine 406 may record a registered voter selection for a selected candidate and/or selected proposition. In an aspect, the secure recordation engine 406 may securely record the selection by at least one of an encrypted version of the registered voter selection, a computer-generated hash of the registered voter selection, recording on a voting blockchain, storing the registered voter selection with a password or a combination thereof.

A database 405 may be operatively connected to the interpreting/parsing engine 402. The database 405 may be contained within the interpreting/parsing engine 402, located remotely from the interpreting/parsing engine 402 or may be a distributed database across a network and connected devices. The database 405 may store voter registration records, public voter information candidate and proposition information, election schedules, location of elections, background information on candidates and propositions, software code for the interpreting filter engine 404 and other engines within the interpreting/parsing engine 402. In an aspect, the database 405 may also store the selected candidate and/or selected proposition in a secure registered voter database associated with and only accessible by the registered voter.

Once the registered voter selects a candidate and/or proposition (or a plurality of each), the secure voting application and system 400 will employ communication engine 408. The communication engine 408 may securely transmit via the secure ballot application, the selected candidate and/or selected proposition to a secure voting recordation database.

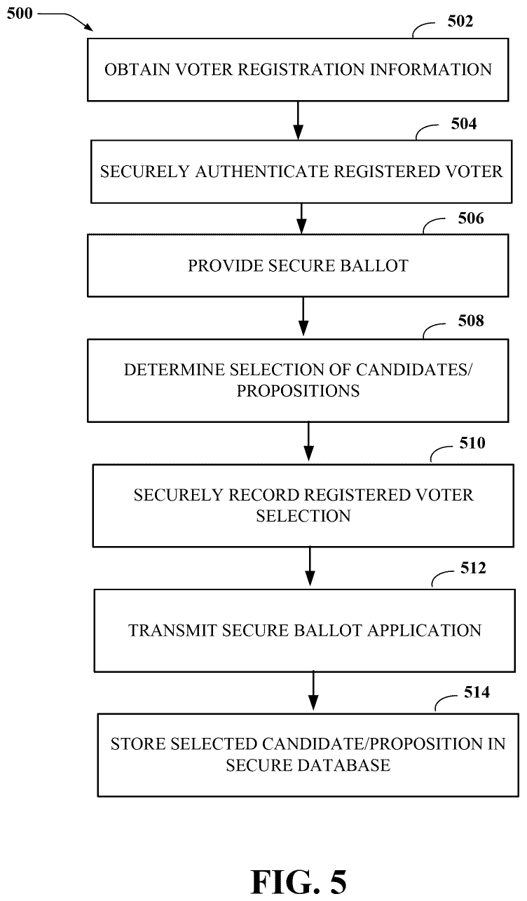

FIG. 5 illustrates a flowchart 500 for acts taken in an exemplary method for providing secure voting for a registered voter. FIG. 5 is explained in conjunction with FIG. 1 to FIG. 4. The control starts at act 502.

At act 502, the secure voting system and application 100 may obtain voter registration information about the registered voter desiring to cast a vote in an election. In an aspect of the disclosure, the voter registration information may include voter registration identification (such as name, date of birth, location of registration, party affiliation, demographic information or other registration information that may be pertinent to a voter registration or whatever the acceptable form of identification that is required to vote in a given ballot or jurisdiction).

At act 504, the secure voting system and application 100 may securely authenticate the registered voter based on identifying information provided by the registered voter and/or public voter information and matching the identifying information with a voter registration record. In an aspect, the secure voting system and application 100 may authenticate the registered voter by securely authenticating with at least one of a driver's license, birth certificate, passport, green card or other national identification document, fingerprints, visa, biometric authentication, two-factor authentication or a combination thereof.

In an aspect, the secure voting system and application 100 may securely authenticate the registered voter comprises authenticating with at least one of a driver's license, birth certificate, passport, green card or other national identification document, fingerprints, visa, biometric authentication, two-factor authentication, photo captured by or stored by a mobile device or a combination thereof or a combination thereof.

At act 506, the secure voting system and application 100 may provide, by a secure ballot application, a ballot for the election, where the ballot comprises at least one of candidate information, propositions in the election, instructions for completing the ballot or a combination thereof. In an aspect of the disclosure, the secure ballot application may be an application, app, applet, webpage script, Windows or Mac application or other coded format for preparing a ballot for a registered voter to interact with and record a vote in an election. In an aspect, the ballot may be prepared and presented by the secure ballot application via a smart device (phone, tablet, “phablet”), a wearable mobile device (watch, AR/VR goggles, interactive hand-motion sensors, etc) or through a desktop computer or server as applicable for the election in question.

At act 508, the secure voting system and application 100 may determine, by the secure ballot application, from historical preferences, candidate information, personal profile of the registered voter, proposition background or a combination thereof, a selection of a preferred candidate and/or preferred proposition for the registered voter. In an aspect, the secure voting system and application 100 may determine, by the secure ballot application, from historical preferences, candidate information, personal profile of the registered voter, proposition background or a combination thereof, a selection of a preferred candidate and/or preferred proposition for the registered voter by training and using a machine learning model to determine the selection of the preferred candidate and/or preferred proposition for the registered voter.

In aspect, the selection of the preferred candidate and/or preferred proposition may be performed by accessing a secure database of public, private and/or the voter's personal information and voting records and voting preferences. Examples of voting preferences may include, but are not limited to, demographic information, party or candidate affiliation, political interests and issues that the voter is concerned about, voting history, membership in groups, lobbies, political organizations, charities or other information that may be pertinent to the registered voter in selecting a candidate or proposition on a ballot in an election.

In an aspect, the trained machine learning model may include, but is not limited to, neural networks, deep learning, linear regression, decision trees, random forest, and XGBoost. Any or all of these machine learning models may serve as or be incorporated into an artificial intelligence model or algorithm.

At act 510, the secure voting system and application 100 may securely record a registered voter selection for a selected candidate and/or selected proposition. In aspect, the secure voting system and application 100 may securely record the registered voter selection comprises recording by at least one of an encrypted version of the registered voter selection, a computer-generated hash of the registered voter selection, recording on a voting blockchain, storing the registered voter selection with a password or a combination thereof.

At act 512, the secure voting system and application 100 may transmit, via the secure ballot application, the selected candidate and/or selected proposition to a secure voting recordation database. In an aspect, as with the security features associated with authentication of the registered voter and recording the registered voter selection, the secure voting system and application may employ an encrypted version of the registered voter selection, an encrypted messaging application such as Telegram, a coded wireless signal, a computer-generated hash of the registered voter selection, recording on a voting blockchain, storing the registered voter selection with a password or passcode or a combination thereof. In aspect, the secure voting system and application 100 may provide a receipt to the registered voter of the received ballot application.

At act 514, the secure voting system and application 100 may store the selected candidate and/or selected proposition in a secure registered voter database associated with and only accessible by the registered voter. The secure registered voter database may be locally stored and accessed on a register voter's mobile device, stored in a remote database(s) or stored in a distributed database. In an aspect, as with the secure authentication, secure recordation and secure transmission, the secure voting system and application 100 may require authentication or access to the database using at least one of an encrypted version of the registered voter selection, a computer-generated hash of the registered voter selection, recording on a voting blockchain, storing the registered voter selection with a password or a combination thereof. In an aspect, the registered voter may grant access to the stored selected candidate and/or proposition to another user, such as voting registration organizations or companies, friends, candidates in the election, social media or other parties or platforms where the voter selection information may be of interest and where the registered voter wants to grant access to for personal or political reasons.

In an aspect, the secure voting system and application 100 may determine a location and timestamp of the registered voter by a positioning device; provide information to the registered voter regarding voting districts, election schedule; allow the registered voter to record the selected candidate and/or the selected proposition if the determined location and determined timestamp are acceptable for the election schedule; and prohibiting the registered voter from recording the selected candidate and/or selected proposition if the determined location and the determined timestamp are invalid for the election schedule. These features may be useful in determining what election district, election or ballot or voting time schedule is accessible to the registered voter. The secure voting system and application 100 may determine the location and timestamp of the registered voter from location devices and applications on a user's mobile device, such as WiFi, GPS, cellular positioning systems, Bluetooth, terrestrial and satellite radio positioning systems, manual input of location and time by the registered voter or other positioning and timestamping systems and applications known to one of skill in the art.

In an aspect, the secure voting system and application 100 may allow the registered voter to save ballot selection information before exiting the secure ballot application; and allowing the registered voter to reopen the saved ballot selection information upon reopening the secure ballot application. In an aspect of the disclosure, the secure voting system and application 100 may require re-authentication of the registered voter to use the application again.

In an aspect, the secure voting system and application 100 may allow the registered voter to pause an execution of the secure ballot application; query additional candidate information and/or additional proposition information related to the election; and restart the paused execution of the secure ballot application.

In an aspect, the secure voting system and application 100 may recording the registered voter selection as a no-vote selection for the selected candidate and/or the selected proposition. This may be useful when the registered voter does not like any of the candidates and/or propositions or wants to record a vote in protest by selecting none of the offered candidates and/or propositions on the ballet.

In an aspect, the secure voting system and application 100 may allow the registered voter to change the registered voter selection before transmitting the selected candidate and/or the selected proposition.

It is understood by one of skill in the art that blocks of the flowchart 500 support combinations of means for performing the specified functions and combinations of operations for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present disclosure and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer implemented method to manage secure voting for a registered voter, the method comprising:
obtaining voter registration information about the registered voter desiring to cast a vote in an election;
securely authenticating the registered voter based on identifying information provided by the registered voter and matching the identifying information with a voter registration record;
providing, by a secure ballot application, a ballot for the election, where the ballot comprises at least one of candidate information, propositions in the election, instructions for completing the ballot or a combination thereof;
determining, by the secure ballot application, from historical preferences, candidate information, personal profile of the registered voter, proposition background or a combination thereof, a selection of a preferred candidate and/or preferred proposition for the registered voter;
securely recording a registered voter selection for a selected candidate and/or selected proposition;
securely transmitting, via the secure ballot application, the selected candidate and/or selected proposition to a secure voting recordation database;
storing the selected candidate and/or selected proposition in a secure registered voter database associated with and only accessible by the registered voter; and
providing a copy of a receipt of the selected candidate and/or selected proposition to the registered voter.

2. The method of claim 1, further comprising:
determining a location and timestamp of the registered voter by a positioning device;
providing information to the registered voter regarding voting districts, election schedule;
allowing the registered voter to record the selected candidate and/or the selected proposition if the determined location and determined timestamp are acceptable for the election schedule; and
prohibiting the registered voter from recording the selected candidate and/or selected proposition if the determined location and the determined timestamp are invalid for the election schedule.

3. The method of claim 1, further comprising allowing the registered voter to save ballot selection information before exiting the secure ballot application; and allowing the registered voter to reopen the saved ballot selection information upon reopening the secure ballot application.

4. The method of claim 1, further comprising: allowing the registered voter to pause an execution of the secure ballot application; query additional candidate information and/or additional proposition information related to the election; and restart the paused execution of the secure ballot application.

5. The method of claim 1, where recording the registered voter selection comprises recording a no-vote selection for the selected candidate and/or the selected proposition.

6. The method of claim 1, where recording the registered voter selection comprises allowing the registered voter to change the registered voter selection before transmitting the selected candidate and/or the selected proposition.

7. The method of claim 1, where securely authenticating the registered voter comprises authenticating with at least one of a driver's license, birth certificate, passport, green card, fingerprints, visa, biometric authentication, two-factor authentication, photo captured by or stored by a mobile device or a combination thereof.

8. The method of claim 1, where securely recording the registered voter selection comprises recording by at least one of an encrypted version of the registered voter selection, a computer-generated hash of the registered voter selection, recording on a voting blockchain, storing the registered voter selection with a password or a combination thereof.

9. The method of claim 1, where determining, by the secure ballot application, from historical preferences, candidate information, personal profile of the registered voter, proposition background or a combination thereof, a selection of a preferred candidate and/or preferred proposition for the registered voter by training and using a machine learning model to determine the selection of a preferred candidate and/or preferred proposition for the registered voter.

10. A system to manage secure voting for a registered voter, comprising:
at least one memory configured to store computer executable instructions; and
at least one processor configured to execute the computer executable instructions to: obtain voter registration information about the registered voter desiring to cast a vote in an election;
securely authenticate the registered voter based on identifying information provided by the registered voter and/or public voter information and matching the identifying information with a voter registration record;
provide, by a secure ballot application, a ballot for the election, where the ballot comprises at least one of candidate information, propositions in the election, instructions for completing the ballot or a combination thereof;
determine, by the secure ballot application, from historical preferences, candidate information, personal profile of the registered voter, proposition background or a combination thereof, a selection of a preferred candidate and/or preferred proposition for the registered voter;
securely record a registered voter selection for a selected candidate and/or selected proposition;
securely transmit, via the secure ballot application, the selected candidate and/or selected proposition to a secure voting recordation database; and
storing the selected candidate and/or selected proposition in a secure registered voter database associated with and only accessible by the registered voter.

11. The system of claim 10, where the computer executable instructions further comprise computer executable instruction to:
determine a location and timestamp of the registered voter by a positioning device;
provide information to the registered voter regarding voting districts, election schedule;
allow the registered voter to record the selected candidate and/or the selected proposition if the determined location and determined timestamp are acceptable for the election schedule; and
prohibit the registered voter from recording the selected candidate and/or selected proposition if the determined location and the determined timestamp are invalid for the election schedule.

12. The system of claim 10, further comprising allowing the registered voter to save ballot selection information before exiting the secure ballot application; and allowing the registered voter to reopen the saved ballot selection information upon reopening the secure ballot application.

13. The system of claim 10, further comprising: allowing the registered voter to pause an execution of the secure ballot application; query additional candidate information and/or additional proposition information related to the election; and restart the paused execution of the secure ballot application.

14. The system of claim 10, where recording the registered voter selection comprises recording a no-vote selection for the selected candidate and/or the selected proposition.

15. The system of claim 10, where recording the registered voter selection comprises allowing the registered voter to change the registered voter selection before transmitting the selected candidate and/or the selected proposition.

16. The system of claim 10, where securely authenticating the registered voter comprises authenticating with at least one of a driver's license, birth certificate, passport, green card, fingerprints, visa, biometric authentication, two-factor authentication, photo captured by or stored by a mobile device or a combination thereof.

17. A computer program product comprising a non-transitory computer readable medium having stored thereon computer executable instructions, which when executed by one or more processors, cause the one or more processors to carry out operations to manage secure voting for a registered voter, the operations comprising:
obtaining voter registration information about the registered voter desiring to cast a vote in an election;
securely authenticating the registered voter based on identifying information provided by the registered voter and matching the identifying information with a voter registration record;
providing, by a secure ballot application, a ballot for the election, where the ballot comprises at least one of candidate information, propositions in the election, instructions for completing the ballot or a combination thereof;
determining, by the secure ballot application, from historical preferences, candidate information, personal profile of the registered voter, proposition background or a combination thereof, a selection of a preferred candidate and/or preferred proposition for the registered voter;
securely recording a registered voter selection for a selected candidate and/or selected proposition;
securely transmitting, via the secure ballot application, the selected candidate and/or selected proposition to a secure voting recordation database; and
storing the selected candidate and/or selected proposition in a secure registered voter database associated with and only accessible by the registered voter.

18. The computer program product of claim 17, where securely authenticating the registered voter comprises authenticating with at least one of a driver's license, birth certificate, passport, fingerprints, visa, biometric authentication, two-factor authentication or a combination thereof.

19. The computer program product of claim 17, where securely recording the registered voter selection comprises recording by at least one of an encrypted version of the registered voter selection, a computer-generated hash of the registered voter selection, recording on a voting blockchain, storing the registered voter selection with a password or a combination thereof.

20. The computer program product of claim 19, where determining, by the secure ballot application, from historical preferences, candidate information, personal profile of the registered voter, proposition background or a combination thereof, a selection of a preferred candidate and/or preferred proposition for the registered voter by training and using a machine learning model to determine the selection of a preferred candidate and/or preferred proposition for the registered voter.
